(19) United States
(12) Patent Application Publication
(10) Pub. No.: US 2025/0238633 A1
(43) Pub. Date: Jul. 24, 2025

(54) AUTOMATIC INTERPRETATION BY MACHINE LEARNING MODELS

(71) Applicant: University of South Florida, Tampa, FL (US)

(72) Inventor: John Licato, Tampa, FL (US)

(21) Appl. No.: 19/032,748

(22) Filed: Jan. 21, 2025

Related U.S. Application Data
(60) Provisional application No. 63/622,645, filed on Jan. 19, 2024.

(51) Int. Cl. G06F 40/40

(52) U.S. Cl. CPC G06F 40/40

(57) ABSTRACT

An example system includes: a first large language model; a memory storing instructions and one or more processors operable to execute the instruction to: receive a natural language text string from a client device, where the natural language text string comprises a formal rule expressed in natural language; input the natural language text string and a control string into a large language model (LLM), where the control string is configured to cause the LLM to generate a formal expression representing the formal rule of the natural language text string; output, by the large language model, the formal expression to an output device; and evaluate a consistency of the formal expression using a test input.

### CROSS-REFERENCE TO RELATED APPLICATIONS

This application claims the benefit of U.S. provisional patent application No. 63/622,645, filed on Jan. 19, 2024, and titled “Shot Selection to Determine Legality of Actions in a Rule-Heavy Environment,” the disclosure of which is expressly incorporated herein by reference in its entirety.

### GOVERNMENT SUPPORT

This invention was made with government support under the 2023 Air Force Research Lab Summer Faculty Fellowship Program awarded by the Air Force Office of Scientific Research. The government has certain rights in the invention.

### BACKGROUND

Machine learning models can include language models, which include probabilistic models of natural language. Language models can be used to both generate new text and analyze the meaning of input text. Language models can be trained based on a corpus of input text that is related to the desired outputs of the language model. For example, a language model for software code can be trained using a corpus of software text.

Large language models are language models that extend the techniques of language models using large datasets. By training a language model using a large amount of text of different types, the language model can have the capability to analyze and output many different types of text. Large language models can require large amounts of memory and processing power to implement.

Natural language processing is a field of computer science that focuses on the interpretation of text in natural language. Formal texts like instructions, commands, rules, laws, etc. are often written in natural language. Accordingly, improvements to natural language processing can improve the ability of computer systems to work with formal texts.

Improving machine learning models and language models, including large language models, can improve the analysis and generation of text.

### SUMMARY

In some aspects, implementations of the present disclosure include a system including: a first large language model; a memory storing instructions and one or more processors operable to execute the instruction to: receive a natural language text string from a client device, wherein the natural language text string includes a formal rule expressed in natural language; input the natural language text string and a control string into a large language model (LLM), wherein the control string is configured to cause the LLM to generate a formal expression representing the formal rule of the natural language text string; output, by the large language model, the formal expression to an output device; and evaluate a consistency of the formal expression using a test input.

In some aspects, implementations of the present disclosure include a system, wherein the formal expression includes Boolean logic.

In some aspects, implementations of the present disclosure include a system, wherein the formal expression includes programming language syntax.

In some aspects, implementations of the present disclosure include a system wherein the memory includes additional executable instructions that, when executed by the one or more processors cause the one or more processors to: create a modified control string based on the consistency of the formal expression; input the natural language text string and the modified control string into the large language model; and output, by the large language model, a second formal expression.

In some aspects, implementations of the present disclosure include a system, wherein the modified control string is configured to configure the large language model to improve the consistency of the second formal expression.

In some aspects, implementations of the present disclosure include a system, wherein the test input includes a plurality of inputs and a plurality of corresponding outputs for the formal expression.

In some aspects, implementations of the present disclosure include a system, further including a second large language model, and wherein the memory includes additional executable instructions that, when executed by the one or more processors cause the one or more processors to: generate, by a second large language model, the plurality of inputs and the plurality of corresponding outputs for the formal expression.

In some aspects, implementations of the present disclosure include a computer-implemented method of natural language processing including: receiving a natural language text string, wherein the natural language text string includes a formal rule expressed in natural language; inputting the natural language text string and a control string into a large language model (LLM), wherein the control string is configured to cause the LLM to generate a formal expression representing the formal rule of the natural language text string; outputting, by the large language model, the formal expression; and evaluating a consistency of the formal expression using a test input.

In some aspects, implementations of the present disclosure include a computer-implemented method, wherein the formal expression includes Boolean logic.

In some aspects, implementations of the present disclosure include a computer-implemented method, wherein the formal expression includes programming language syntax.

In some aspects, implementations of the present disclosure include a computer-implemented method, further including: creating a modified control string based on the consistency of the formal expression; inputting the natural language text string and the modified control string into the large language model; and outputting, by the large language model, a second formal expression.

In some aspects, implementations of the present disclosure include a computer-implemented method, wherein the modified control string is configured to configure the large language model to improve the consistency of the second formal expression.

In some aspects, implementations of the present disclosure include a computer-implemented method, wherein the test input includes a plurality of inputs and a plurality of corresponding outputs for the formal expression.

In some aspects, implementations of the present disclosure include a computer-implemented method, wherein the method further includes generating, by a second large language model, the plurality of inputs and the plurality of corresponding outputs for the formal expression.

In some aspects, implementations of the present disclosure include a non-transitory computer-readable medium storing instructions thereon which, when executed by one or more processors, cause one or more computers to perform functions that include: receiving a natural language text string, wherein the natural language text string includes a formal rule expressed in natural language; inputting the natural language text string and a control string into a large language model (LLM), wherein the control string is configured to cause the LLM to generate a formal expression representing the formal rule of the natural language text string; outputting, by the large language model, the formal expression; and evaluating a consistency of the formal expression using a test input.

In some aspects, implementations of the present disclosure include a non-transitory computer-readable medium, wherein the formal expression includes programming language syntax or Boolean logic.

In some aspects, implementations of the present disclosure include a non-transitory computer-readable medium, further including additional executable instructions that, when executed by the one or more processors cause the one or more processors to: create a modified control string based on the consistency of the formal expression; input the natural language text string and the modified control string into the large language model; and output, by the large language model, a second formal expression.

In some aspects, implementations of the present disclosure include a non-transitory computer-readable medium, wherein the modified control string is configured to configure the large language model to improve the consistency of the second formal expression.

In some aspects, implementations of the present disclosure include a non-transitory computer-readable medium, wherein the test input includes a plurality of inputs and a plurality of corresponding outputs for the formal expression.

In some aspects, implementations of the present disclosure include a non-transitory computer-readable medium, further including additional executable instructions that, when executed by the one or more processors cause the one or more processors to: generate, by a second large language model, the plurality of inputs and the plurality of corresponding outputs for the formal expression.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates a system block diagram of a system for implementing machine learning techniques according to implementations of the present disclosure.

FIG. 2 illustrates a method for generating formal representations of a text string, according to implementations of the present disclosure.

FIG. 3 illustrates an example map and grid, according to implementations of the present disclosure.

FIG. 4 illustrates a compound action as a series of atomic actions.

FIG. 5 illustrates an example method including prompting users for actions which are allowed or disallowed, and user inputs of action utterances, according to implementations of the present disclosure.

FIG. 6 illustrates an example of disallowed action strings, according to implementations of the present disclosure.

FIG. 7 illustrates an example of experimental results including accuracy for different example implementations of the present disclosure.

FIG. 8 illustrates an alternative experimental result to the one shown in FIG. 7, according to implementations of the present disclosure.

FIG. 9 illustrates an example method for generating formal representations of text, according to implementations of the present disclosure.

FIG. 10 is an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for generating formal analyses of rules, it will become evident to those skilled in the art that the implementations are not limited thereto, but are applicable for training and fine tuning other types of machine learning models.

Described herein are systems and methods of automatically analyzing text, including by generating formal interpretations of natural language.

Existing machine learning models, including large language models (LLMs), can be difficult to apply consistently because both the inputs and outputs to such models can be natural language text. Moreover, LLMs can be “black boxes” where the transformation between the input and output is difficult to analyze or model. Likewise, existing machine learning models can fail to produce formal structured outputs that conform to the expectations of an operator or system designer. These problems limit the uses of LLMs in computer systems and can prevent LLMs from being used to perform automatic analysis of text using LLMs.

Implementations of the present disclosure address these and other problems with existing LLMs and LLM systems. For example, implementations of the present disclosure improve the training, fine tuning, and deployment of machine learning models by structuring the outputs of LLMs to enable testing and analysis of the LLMs.

An example implementation can include a system that configures the LLM to generate a structured output corresponding to a section of natural language text (e.g., a string of natural language). The structured output can then be analyzed, and the configuration of the LLM can be adjusted (e.g., automatically adjusted) based on the structured output. The example implementation thereby allows for iterative configuration of an LLM based on a formal analysis of a structured output. This can improve over conventional uses of an LLM where the output of the LLM is an unstructured output (e.g., natural language) that may be difficult or impossible to formally analyze.

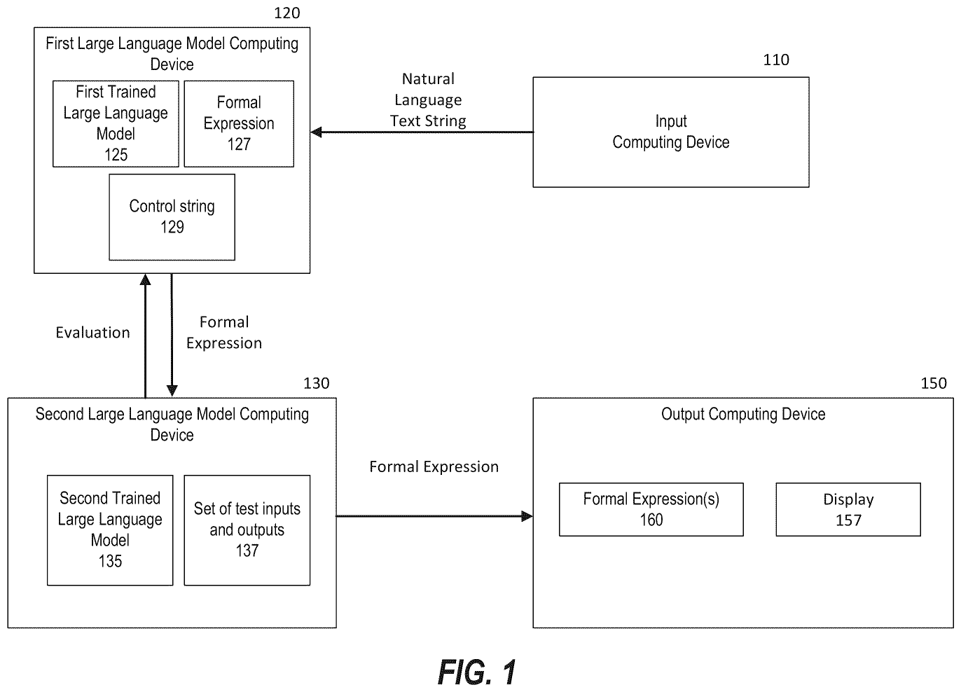

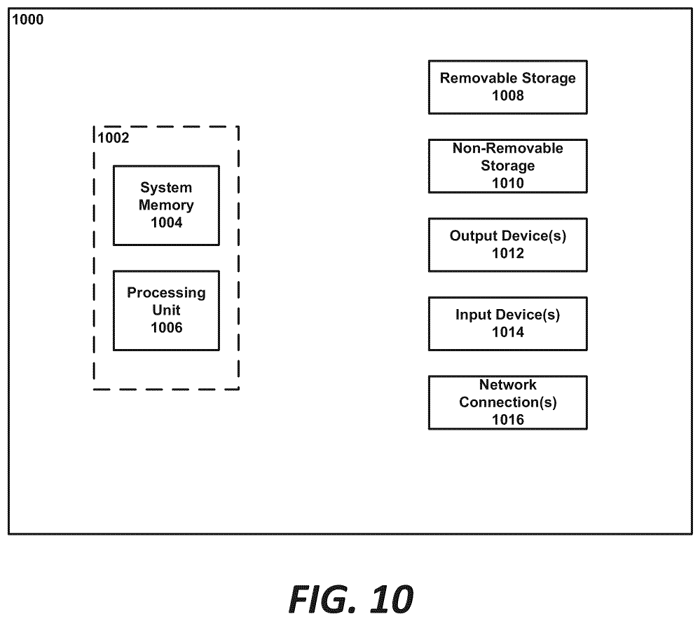

With reference to FIG. 1, an example system is shown according to implementations of the present disclosure. The system can include an input computing device 110. The input computing device 110 can optionally include any or all of the components of the computing device 1000 described in FIG. 10. The input computing device 110 is configured to receive one or more natural language text strings. Optionally, the input computing device 110 can be configured for user input of one or more text strings. Alternatively or additionally, the input computing device 110 can be configured as a database storing any number of text strings.

As used herein, a “natural language text string” refers to unstructured human language (e.g., English, Spanish, French, Chinese, etc.) The natural language text strings described herein can include natural language representations of formal rules. As used herein, a “formal rule” refers a next string that represents a conditional statement. Examples of formal rules include laws, commands, and other rules that expressly prohibit, command, or require certain actions. For example, laws are often natural language conditional statements that require and forbid certain actions in order to avoid punishment or obtain benefits. As another example, commands (e.g., controlling a machine or system) can be in the form of natural language statements that express the desired outcome that should be satisfied (e.g., “run the cycle 10 times” or “repeat the last action”). As non-limiting examples, the natural language text strings herein can be representations of spoken language (e.g., converted by speech-to-text inputs/systems of the input computing device 110), direct user inputs by the input computing device 110, and/or inputs obtained from a database of the input computing device 110.

The input computing device 110 can be in operable communication with a first large language model computing device 120. The first large language model computing device 120 can optionally include any or all of the components of the computing device 1000 described in FIG. 10. The first large language model computing device 120 can include at least one first trained large language model 125 stored in a memory of the first large language model computing device 120. The first trained large language model 125 can optionally be a model that is fine tuned for generating formal expressions based on a natural language input. As used herein, a “formal expression” refers to a language or notation that is designed to eliminate or reduce ambiguity when compared to natural language. Boolean logic, computer programming languages, and mathematical notations are non-limiting examples of formal expressions. The formal expression 127 output by the first trained large language model 125 can also be stored by the first large language model computing device 120.

The first large language model computing device 120 can further be configured to store a control string 129 in memory. As used herein, a “control string” refers to text or other data used to configure the first trained large language model 125. The control string 129 can be combined with the natural language text strings to configure the response of the first trained large language model 125 to the natural language text string.

Still with reference to FIG. 1, the system can include a second large language model computing device 130 with a second trained large language model 135 and a set of test inputs and outputs 137. The second large language model computing device 130 can optionally include any or all of the components of the computing device 1000 described in FIG. 10. The first large language model computing device 120 can be configured to output the formal expression 127 to the second large language model computing device 130. In response, the second large language model computing device 130 can be configured to test the formal expression 127 using a set of test inputs and outputs 137 stored in a memory of the second large language model computing device 130. The outputs of the test inputs and outputs 137 can correspond to the inputs, such that the outputs represent the result of a correct evaluation of the test inputs. For example, if a test input represents a violation of the rule, then the corresponding test output can be “true” or “violated.” As another example, if the rule is to determine whether an item or behavior belongs to a certain category, then the inputs can be example items, and the outputs can be whether or not those items belong to the category (e.g., if the category is “plant”, a test input may be “fern” and the corresponding test output may be “true”, but if the test input is “bucket” then the corresponding test output may be “false”).

The set of test inputs and outputs 137 can include examples that test whether the formal expression 127 accurately represents the meaning of the natural language text string. The set of test inputs and outputs 137 can include inputs that represent a situation related to the natural language text string, and outputs that represent a desired response to the natural language text string. For example, if the natural language text string represents a rule, the inputs can represent situations that are relevant to the rule, and the corresponding outputs can represent whether the situations are permitted or violations of the rule.

Optionally, the second large language model computing device 130 can be configured to evaluate whether the formal expression 127 is a consistent representation of the natural language text string. As used herein, “consistent” or “consistency” refers to the degree to which a formal expression created by the first large language model computing device 120 accurately represents the natural language text string input to the first large language model computing device 120. The evaluation of the formal expression 127 can optionally be performed using the second trained large language model 135, and/or by inputting the set of test inputs and outputs 137 to the formal expression 127 and determining whether the formal expression determines the correct outputs based on the inputs. In some implementations, the output computing device 150 can be configured to evaluate test inputs by running generated code and/or logic on test inputs. Alternatively or additionally, the second trained large language model 135 can be configured to evaluate the test inputs. In implementations where the second trained large language model 135 evaluates the inputs, the second trained large language model 135 can be configured to improve the set of test inputs and outputs 137 based on the evaluation of the test inputs by the second trained large language model.

Optionally, the second trained large language model 135 can be configured to create test inputs and/or outputs for the set of test inputs and outputs 137. The second large language model 135 can optionally be a different type of large language model from the first trained large language model 125. This allows for the first trained large language model 125 to be a specialized model (e.g., a model trained for generating code) and the second trained large language model 135 to be a generalist model or other type of model. Specialized models can be Accordingly, the system and methods of the present disclosure can be used to combine different large language models to improve the resulting outputs and systems.

Optionally, the formal expression 127 can be output by the second large language model computing device 130 to an output computing device 150. The output computing device 150 can optionally be part of a machine, control system, etc. Alternatively or additionally, the output computing device 150 can include a display 157 and be a user device configured for display or analysis of the formal expression 127. The output computing device 150 can store any number of formal expressions 160 in a database so that a user can optionally review the formal expressions 160. Optionally, the output computing device 150 can be further configured to receive the natural language text strings that correspond to each formal expression 127 so that the relationship between natural language inputs and formal expression outputs can be analyzed.

Additionally, the systems and methods of the present disclosure improve systems including LLMs by structuring the resulting outputs and structuring the evaluation of those outputs. As noted throughout the present disclosure, the “black box” nature of machine learning models is a significant technical challenge for using machine learning models in industrial settings. The systems and methods described herein systems including LLMs by structuring the outputs of LLMs as formal expressions that can be checked automatically (e.g., by test inputs/outputs) or manually inspected by human users.

As another non-limiting example, the systems and methods described herein can be used to improve the functioning of machines that use natural language commands. For example, the input computing device 110 can be a microphone, keyboard, mobile device (e.g., smartphone) etc. A user can input a command to a machine by natural language (e.g., speech or text) that the input computing device records as a natural language text string. The first large language model computing device 120 can convert the user input into a formal expression 127 using the control string 129. The formal expression 127 can then represent program code to control the machine.

As yet another a non-limiting example, implementations of the present disclosure allow for automated interpretation of natural language rules. If a natural language rule states “No vehicles are permitted in the park” (a natural language text string), this natural language rule can be considered to include an ambiguity because the term “vehicle” is not defined. The string can be input to the first large language model computing device 120, which can generate a formal expression 127 that interprets what a vehicle is. For example, the formal expression 127 may be a Boolean or programming language expression that returns “true” when certain conditions are met (e.g., “(has an engine AND at least one wheel) OR (has peddles AND at least four wheels)”).

The formal expression 127 can then be evaluated by the second large language model computing device 130 to determine whether the interpretation of vehicle is consistent with a set of test inputs and outputs 137. For example, test inputs and outputs can be: a wagon (4 wheels, no engine; not a vehicle), a snowmobile (has an engine, but no wheels; vehicle), and a bicycle (has peddles, and two wheels; not a vehicle). Evaluating the example formal expression 127 above, the wagon and bicycle would be correctly marked as not vehicles, however, the snowmobile would also be evaluated as not a vehicle because it lacks wheels. Thus, the formal expression 127 is only partially consistent with the test inputs and outputs 137. Based on the resulting inconsistency with the formal expression and the test inputs and outputs 137, the control string 129 can optionally be automatically updated by the first large language model computing device 120 or second large language model computing device 130. For example, the control string can be re-configured to prompt the first trained large language model 125 to consider “vehicles without wheels.”

Optionally, the same natural language text string can be re-input to the first trained large language model 125 to generate a new formal expression 127 using the updated control string 129. Again as a non-limiting example, the new formal expression 127 may be “(has an engine AND can move) OR (has peddles AND at least four wheels)”). The new formal expression 127 can be re-evaluated again using the set of test inputs and outputs 137. Using the new formal expression 127, the snowmobile would be a vehicle, as it moves and includes an engine. Thus, the revised formal expression is now consistent with the set of test inputs and outputs 137. The revised formal expression can be output for review.

For example, if the machine is a vehicle, the natural language input may be “stop.” This natural language command can be ambiguous because it may not be clear whether “stop” refers to stopping the engine, the radio, the windshield wipers, etc. When the natural language text string “stop” is input to the first large language model computing device 120 the resulting formal expression 127 may be program code to stop the engine of the vehicle. The formal expression 127 can be input to the second large language model computing device 130 to determine whether the program code (i.e., the formal expression 127) stopping the engine is consistent with the input. If the formal expression 127 is consistent with the natural language text string, then the formal expression can be sent to the output computing device 150 (e.g., by executing the program code on the vehicle to stop the engine). However, if the formal expression 127 is not consistent with the natural language text string, the control string 129 of the first large language model computing device 120 can optionally be revised to re-interpret the input.

It should be understood that the input computing device 110, first large language model computing device 120, second large language model computing device 130, and output computing device 140 can be implemented using any number and combination of computing devices. For example, in some implementations of the present disclosure, both the first trained large language model 125 and second trained large language model 135 can be implemented using the same computing device. As another example, alternatively or additionally, the input device 110 and output device 150 can be implemented using the same computing device.

Additionally, it should be understood that the first large language model computing device 120 and/or second large language model computing device 130 can optionally include specialized hardware configured for performing inference using the first large language model computing device 120 and second large language model computing device 130. For example, large amounts of VRAM and/or processors configured for parallel computing can be used. As used herein, “inference” refers to using a trained large language model to generate a response based on an input. Optionally, the first trained large language model 125 and/or second trained large language model 135 language model can be models fine-tuned on code generation, Boolean logic, or mathematics. The first trained large language model 125 and/or second trained large language model can also utilize a carefully curated instruction set (also known as “input prompts”) that are designed to produce higher quality outputs. The first trained large language model 125 and/or second trained large language model can also include a collection of sub-systems, some of which may not be language model-based, which work together to produce higher quality outputs.

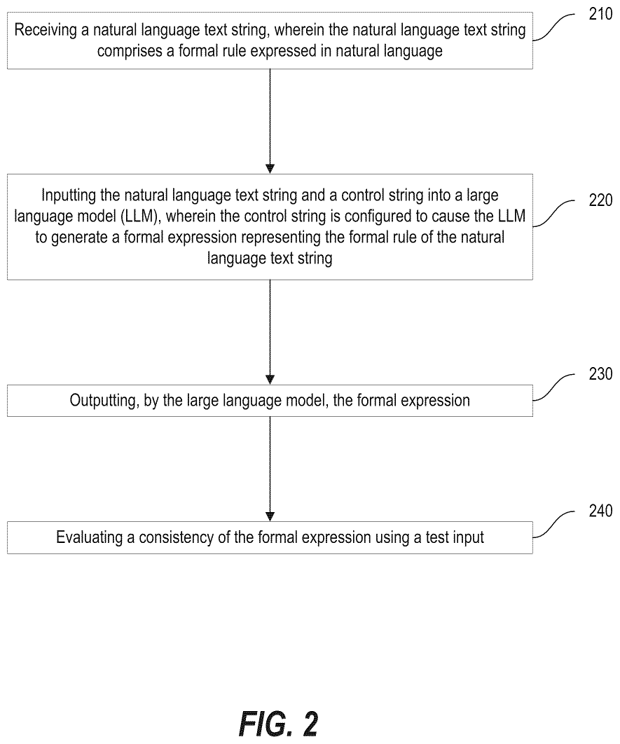

With reference to FIG. 2, implementations of the present disclosure include computer-implemented methods and computer-readable media for natural language processing. Optionally, any of the methods described with reference to FIG. 2 can be implemented using the system of FIG. 1 to automatically analyze natural language text using multiple large language model systems.

At step 210, the computer-implemented method includes receiving a natural language text string, where the natural language text string includes a formal rule expressed in natural language.

At step 220, the computer-implemented method includes inputting the natural language text string and a control string into a large language model (LLM), wherein the control string is configured to cause the LLM to generate a formal expression representing the formal rule of the natural language text string. Optionally, the formal expression can include Boolean logic, programming language syntax, or mathematical syntax.

At step 230, the computer-implemented method includes outputting, by the large language model, the formal expression.

At step 240, the computer-implemented method includes evaluating a consistency of the formal expression using a test input. As described with reference to FIG. 1, any number of test inputs and outputs can be used so that the consistency of the formal expression can be tested against a variety of different inputs.

Optionally, the computer-implemented method can further include creating a modified control string based on the consistency of the formal expression. The natural language text string and the modified control string can be input into the large language model and a second formal expression can be output. The modified control string can be configured to configure the large language model to improve the consistency of the second formal expression. Optionally, the methods described with reference to FIG. 2 can be iteratively repeated to improve the consistency of the resulting formal expressions. For example, any number of formal expressions and modified control strings can be generated to improve the formal expressions and identify formal expressions and control strings that correspond to the most consistent formal expressions. Thus, the systems and methods of the present disclosure enable automatic identification of formal expression that are most consistent with natural language rules.

Optionally, the computer-implemented methods can include using a second large language model as described with reference to FIG. 1. The second large language model can be used to generate and/or evaluate the inputs and the outputs that are used to evaluate the formal expression.

### Example: Rule Analysis using Large Language Models

A study was performed using implementations of the present disclosure to perform rule analysis using machine learning models, including large language models. The example implementation of the present disclosure was configured for generating formal interpretations of rules.

In particular, the study explored a set of rules expressed in real-world regulatory language and an action, and considered whether large language models could determine whether the action is permissible? If not, why not, and what additional information is needed before they can perform this task well? These questions are of significant interest for developing machine learning models that can be used for applications requiring consistent formal outputs. Existing work studying how well LMs can interpret those rules focuses on a narrow set of domains, with little focus on cases where those rules have the complexity of real-world legal systems.

An example implementation of the present disclosure includes LLMs configured to analyze a dataset (e.g., the benchmark, dataset herein from a board game (“BG”) selected for the complexity of its rule set). The study included the effects of shot size, function calls, and example rationales on the quality of reasoning about action permissibility.

Natural language text can include a certain amount of ambiguity, including open-textured term used to allow a certain degree of decision-making flexibility to those who must interpret and apply the rules, [Hart, 1961; Waismann, 1965]. For AI agents to follow human laws, rules, and commands, and interpret them in human-like ways, AI systems can include alignment between how AI interprets rules with open-textured terms and how humans do. [Franklin, 2012; Prakken, 2017; Quandt and Licato, 2020; Licato et al., 2019; Licato and Marji, 2018].

Organizations are using open-textured rules that LMs themselves must interpret to constrain and regulate the behaviors of either themselves or other LMs (e.g., “Guardrails” [Rebedea et al., 2023] and “Constitutional AI” [Bai et al., 2022]), using benchmark datasets of toxicity or ethical behavior as the primary measures of success.

The domain of complex BGs is fruitful and underutilized for studying this problem. GMT's Next War: Taiwan (NW:Taiwan) [Land, 2014] is a large war-based BG with functionality for ground, air, and naval warfare. It includes a standard and advanced set of rules which are used in the entire Next War series and an additional, supplementary set of rules that are specific to the variant (in this case Taiwan). The study created a dataset of complex scenarios and actions, designing a new data collection procedure to do so.

The present example includes a new dataset for a complex BG with a naturalistic rule set containing realistic open-textured language; a methodology for collecting datasets of this type, developing a set of functions that an LM can use to query BG state, etc.; and an investigation into the extent to which the ability to query BG state affects LMs' ability to reason about action permissibility.

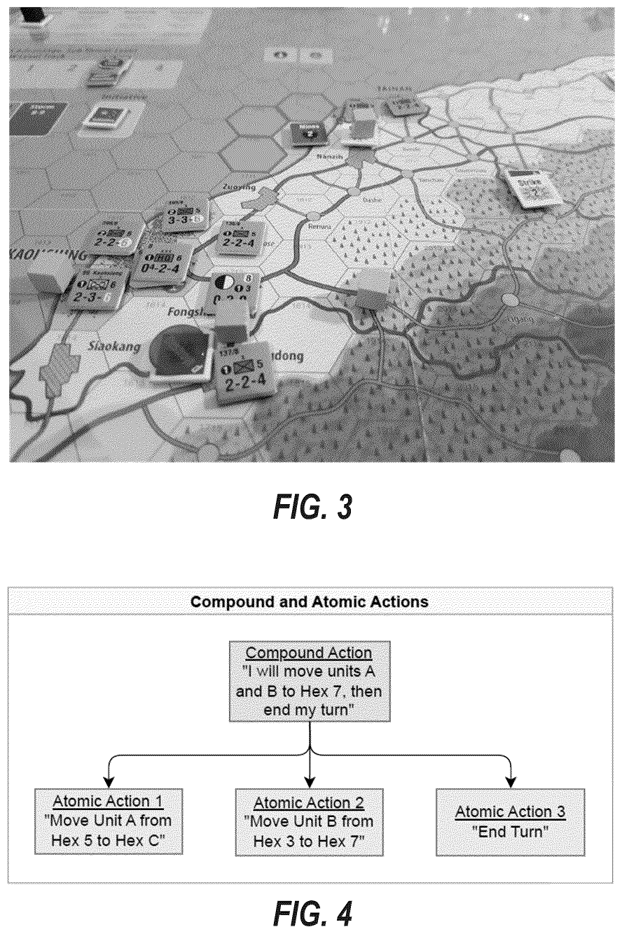

Dataset creation. The example described in the present study includes the creation of a rigorous, methodically verified, benchmark dataset for rule reasoning. This dataset consists of scenarios in a simplified version of NW:Taiwan, and actions in those scenarios expressed in language that are either permitted by the rules, or not permitted. NW:Taiwan is a BG where two actors vie for control of Taiwan by sending troops into battle as either the People's Republic of China (China) or the Republic of China (Taiwan & Allies) [bgg, 2023]. There are locations spread over a geographic map of Taiwan broken down into hexagons (hexes) representing 7.5 miles. An example view of a hex map is shown in FIG. 3. Each actor begins the BG with a certain number of units and an objective, both of which are determined by the scenario. Additionally, the BG has a limited amount of turns and if actors in the BG do not achieve their objective(s) by then, alternate conditions may be used to determine the winner. In the example simplified BG, the scenarios were semi-randomly generated (description below) and both actors have the same objective. Each enemy unit killed is worth one victory point and the actor with the most points at the end of turn five is the winner.

The example implementation started with the BGs ruleset and further simplified the ruleset by limiting the action space and removing rules that referred to the actions that were eliminated, thus allowing the ruleset to focus exclusively on ground combat. The series rules from NW:Poland [Land, 2017], were used because they supersede any previous Series rules. The hex map, BG pieces, charts, etc. were taken from NW:Taiwan. Finally, the study removed any mechanics within the BG which were not directly necessary for a brief guerilla-style ground assault in order to simplify the sequence of actions. This allowed the study to entirely eliminate naval and air warfare, Initiative movement, Reinforcement, and Victory points. Instead, victory was determined by completion of a pre-specified condition.

The resulting simplified BG has the following structure: The weather is randomly initialized for the first BG turn, and the actors roll for weather on every subsequent turn, using the Weather Track provided with the BG. The first actor may move their units following the relevant ground movement rules, then engage in combat following the relevant combat rules. After the first actor completes their movement and combat, the second actor may engage in movement and combat. The study set an example win condition to be the elimination of the enemy army, so the BG ended after both actors had 5 turns or when either actor had no surviving units left.

One advantage of using NW:Taiwan for natural language reasoning is the complexity and, sometimes, the open-textured nature of its rules. For example, while the process to declare an attack is quite well defined, the actual term “attack” is not. The rules state: “The attacker declares the hex being attacked and indicates his attacking units.” Note that the hex is being attacked. Is it intended that actors may attack empty spaces, or is this an oversight? Does this mean that “If the defender's hex is vacant at the conclusion of combat . . . ” means combat can be used to generate additional movement? It may be difficult to recognize when a term that otherwise belongs to the genre of war BG s is representative of a BG mechanic or if it has an alternate meaning in the rules. Casualties, for instance, are supposed to capture a multitude of warfare facets and are even directly referenced on the developer's website: “As in many BGs, casualties represent not only actual combat losses but also losses of unit cohesion brought about by the rapid pace with which modern armies are able to engage and exploit on the battlefield” [gmt, 2023].

The dataset takes advantage of these open-textured rules to capture a wide range of BG play rule/state/action triads, and provide a rich collection of gold labeled data for action permissibility reasoning. If a reasoner, whether AI or human, is to effectively interpret open-textured rules, they must understand these rules within their intended context and align their judgement accordingly. This process mirrors the approach in the United States case law, where a judge may reference previous rulings to support decisions in novel situations. By presenting various actions, both allowed and disallowed, in different contexts, the example implementation can compel a reasoner (e.g., an AI system) to assess the same actions under varying circumstances. Successful reasoning across these contexts for identical actions, and doing so consistently, indicates that the reasoner possesses the capability to apply rules flexibly. This flexibility is crucial, as it enables the reasoner to adapt to scenarios where interpretations are not immediately apparent, reflecting a sophisticated level of understanding.

Utterances and Actions. The example dataset can include of triples: (S,α,c)

Where S is the current BG state, a large JSON object describing all hex positions on the board, the locations and properties of all units, and any other information that could potentially be used in determining whether an action is allowed.

c is a boolean describing whether the action α is allowed or disallowed. The action α consists of two parts: the utterance, which is the actual text spoken by the human actor to describe their action (e.g., “let's move the piece on 2434 to 2435 and then attack”); and the interpreted action. If the utterance corresponds to an allowed action, then the interpreted action will be a sequence of atomic actions, where an atomic action is a type of action that corresponds to a minimal decision that a actor can make (we have defined the set of possible atomic actions prior to dataset construction). An utterance is considered to be allowed if it corresponds straightforwardly to at least one sequence of allowed atomic moves.

Note that an utterance can require some detailed understanding of the rules and current BG state in order to determine whether there is a corresponding set of allowed atomic actions. For example, if a actor is in an attack phase, and they say the utterance “completely end my turn,” then the allowed sequence of atomic moves is to decline to attack, end the attack phase, and then end all subsequent phases in order. Utterances corresponding to disallowed actions may or may not have corresponding interpreted actions: simple utterances may unambiguously translate to a set of atomic actions which are disallowed (e.g., “move the unit on hex 2454 to 2554” may be disallowed if the piece has already moved this turn), or the utterance may be disallowed if there is no clear way to translate it into a set of atomic actions.

For this reason, the study can distinguish between actions that are disallowed because they do not correspond to any allowed atomic actions, and those which correspond to atomic actions which are against the rules. Herein, these are referred to as Disallowed by Scope (DSc), or Disallowed by State (DSt). DSc actions those whose impermissibility should be obvious to anyone with a shallow familiarity with the BG and its rules, and can be determined to be disallowed without even referring to the BG's current state. For example, the utterance “summon a sea monster to attack” can easily be seen as not allowed by the rules. DSt actions, in contrast, require both a deep knowledge of the rules and the ability to query the current state in order to determine they are illegal. In the previous example of moving an already-moved unit, the only way to know this action is allowed or disallowed would be to review the state immediately relevant to the action. It is though the distinction between DSc and DSt that we can determine if our algorithm is merely relying on accumulated knowledge from its training or if it possesses a deep understanding of the rules of the BG.

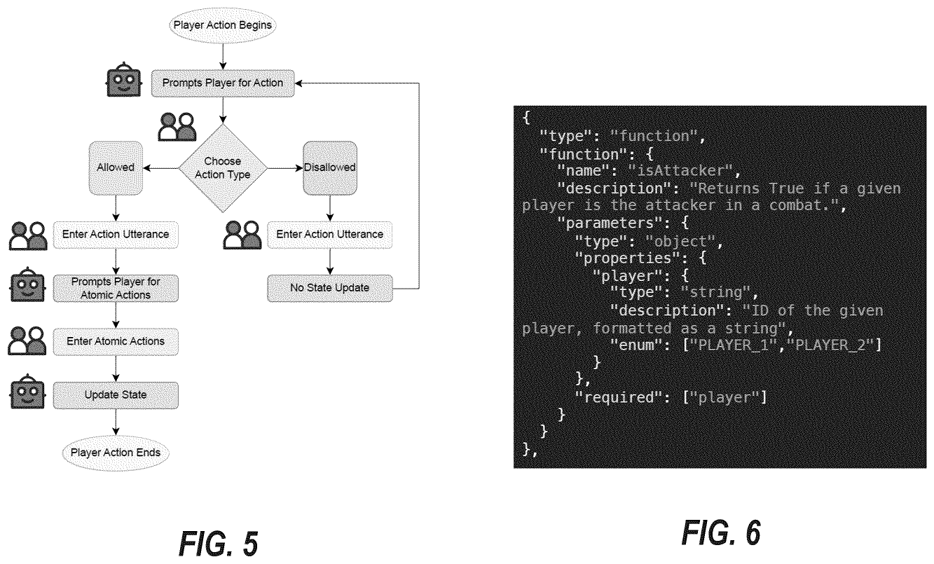

The action structure is graphically shown in FIG. 5. When actors declare actions, the scope is limited to atomic actions that the actors have control over. If a die needs to be rolled, or another actor needs to make a decision, then the uttered action must end before they hand off control. After all, it would not be much of a BG if an actor could declare a die roll in advance or instruct their opponent what to do. Combat is a common point where the actor must wait for outside information before continuing with their turn. The actor does not know how the dice will affect the outcome of combat, and so may not declare actions that extend past this point. Examples of compound and atomic actions are shown in FIG. 4.

Component encoding. Implementations of the present disclosure include component encoding. The procedure used to generate the dataset can divided into three stages: component declaration, BG play entry, and post processing. As the dataset was generated from actor actions during a BG, the physical components must be translated into a digital medium before being utilized. NW:Taiwan has four primary contents that must be digitized: units, board, actor aids, and rules.

To assist in data entry, the example implementation includes scripts to prompt for information on units and the hexagons that comprise the locations on the board. These are simple looping scripts that guide the user in entering the proper information and storing the information in JSON format. Some of the unit information options are hard coded to match the BG while others are string entries. This decision was made to ease entry for the Taiwan version specifically, but also allow for generalizations without too much editing. The NW:Taiwan BG has some vaguely defined instructions on how to treat terrain types that are only minimally present in a hex and so decided to include any features found on a hex in that hexes encoding. For example, if the art of a mountain range overlaps into a neighboring hex we counted the entire hex as having mountainous terrain. Once all of the hex information is encoded, areas between hexes are entered. For example, once hex A and B are entered, the study can then determine the properties shared along their border. Finally, a third script ingests all the hex encodings as well as their connection information to create an adjacency map.

Units, hexes, and adjacencies all utilized encodings to uniquely identify them. Encodings are a four or five digit identifier that uniquely refer to a hex or unit. The BG heavily relies on physical components to distinguish between pieces and so the study gave every unit, adjacency connection, and hex a unique encoding. Hexes are printed on the board and units are tokens that can be picked up and moved. Hexes contain the following information: The hex encoding, terrain type for movement and combat (mountainous, rough, urban, etc.), non-terrain features (bridges, fortifications, etc.), who controls the hex, and many other BG minutia. Units have similar information such as: encodings, which actor controls them, what faction or country they belong to, their attack/defense strength, current hex location (in encoding), movement points, etc.

The dataset also included the rules. While the other components concerned primitive data entry, the gameplay software responsible for assisting in rule compliance provides guidance to actors without strictly enforcing an interpretation of the rules. Otherwise, the software would be enforcing the programmers' understanding of the rules rather than allowing actors to make reasoned decisions. The software allows actors to enter utterances, allowed and disallowed actions, and update the state with atomic actions.

Scenario Generation. The dataset was developed using three actors familiar with the BG and its rules, generating actions over six BGs. There are 246 allowed actions and 268 disallowed actions, for a total of 532 actions. The standard of one allowed action per two disallowed was developed during development, so the ratio was not strictly kept at all points in time. To facilitate a diverse range of actions, the initial setup for each BG-referred to as scenarios-was pseudorandomly generated. To generate a scenario, one actor was randomly assigned between 5 and 10 units. The approximate strength of those units was defined as the sum of their movement allowances, combat strengths, and defenses. The other actor was then randomly assigned units one at a time until their approximate strength matched the initial actor's, in order to ensure a roughly balanced BG. A designated starting location was selected for each actor, and a joint ending location was selected for both actor. Each unit was then placed randomly within two hexes of its starting location. Because the board for NW:Taiwan is hex-based, each unit had up to six adjacent hexes. For each unit, a random adjacent hex was selected and, if allowed, the unit was relocated to that hex. Standard movement rules from the BG were followed, so units were not allowed to enter hexes containing an enemy unit, overstacked hexes, or hexes with prohibited terrains. To promote forward movement, units were also not allowed to enter hexes that they had already traversed. This random movement was repeated one hex at a time until the unit's movement allowance was depleted or the unit became stuck in a position that would be impassable without retreating through a traversed hex. This entire process of random hex selection and relocation until movement was depleted was considered one movement turn. Each unit stopped moving entirely when it arrived within two hexes of the ending location or had completed ten movement turns, whichever came first. These units, their final locations, and a randomly initialized weather pattern comprised the completed scenario.

Board Initialization. When a user begins the driver script, they are presented with an option to either start a new BG from a scenario or load a saved BG. In the case of a new BG, the scenario only contains information about the weather, what units are on the board, where they are, and who owns them. Once the scenario is chosen, this information is used to populate pandas dataframes containing information about hexes, adjacencies, and units mentioned above. In addition to that information, metagame details are also recorded. Metagame information concerns things such as current BG phase, scores, turn, combat information, actor actions, and many other programmatic details. In aggregate, these dataframes form what are referred to herein as the BG state. When a saved BG is loaded, the state is repopulated and the BG continues from that state. These files are formatted as JSON in order to easily reference and load individual dictionaries. As far as the BG driver is concerned, the only thing that matters is the line that contains the state the actor wishes to continue from, so using JSON lines allows us to strip out extraneous formatting. In either case, the actor who has the next decision to make is prompted for an action.

Data Entry. As a use of the dataset is to develop and evaluate an AI pipeline's ability to reason over rules, it can be beneficial to have a diverse range of labeled data. A BG as complex as NW:Taiwan can be used to generate such a diverse range of labeled data. The sheer volume of possible moves, along with randomization in the combat stage, makes static or repetitive BGs across randomly generated scenarios unlikely. To encourage diversity of actions the study chose to implement a two to one ratio of disallowed to allowed actions. Generally, actors will not attempt to wildly deviate from the rules of a BG, but what if they do not know the rules? In order to provide models with actions that are not in the scope of the BG, the study chose to have the first of the two disallowed actions to always be DSc. The second disallowed action is one that is DSt, such as a actor moving out of turn. This is graphically displayed in FIG. 5. Once the actor had entered two disallowed actions, they entered an allowed action. The actor did not try to force specific outcomes with these actions and played the BG as naturally as they could while avoiding overly repetitive actions.

### Experiment

The study included determining how well a state-of-the-art language model can solve the problems in the NW: T dataset, both when given only the rules of the BG, and when given previous examples of how to successfully solve problems. The study divided the dataset into three portions: a dev set (20 action-scenario pairs) a test set (40 action-scenario pairs, balanced across labels) and a train set (296 action-scenario pairs).

The example primary model was OpenAI's GPT-4 Turbo model, specifically gpt-4-606-preview which allows for prompt sizes of up to 128 K tokens, and has a function calling API. The large prompt size allowed the study to include the entire rule set for the simplified version of NW:T. The function calling API allows us to send, as part of the prompts, a JSON object which contains a description of each function that we are making available to GPT-4 as shown in FIG. 6.

The functions made available were designed to allow the LM to access all information about the current BG state that it needed, without needing to directly access the JSON object representing the BG state. The dev set was used to ensure this set of functions was complete and debugged, and we restricted the set of functions to those that were primarily lookup functions—e.g., functions that retrieved information about the board, basic attributes of units, the current BG state, or information in lookup tables. Functions that required reasoning about the rules were not implemented, so that we could test the LMs' ability to do this.

The study used the train set to construct a shot bank that could be drawn upon later. The LM was prompted with the full rule set, and then “We want to perform the following action: ‘[action]’. Given the rules above, is the action legal or illegal? Work step-by-step, explaining your reasoning before giving your answer. Then, after you are done explaining your reasoning, if the action is legal, make the last word in your response ‘LEGAL’. Otherwise, write the last word in your response as ‘ILLEGAL’ and nothing else. If you need more information, use the provided function calls.” The LM was then allowed to make as many function calls as needed, until reaching a conclusion. If it reached the correct answer, then the action-scenario pair, along with the list of function calls made, and the rationale generated by the model for why its answer was correct, was added to the shot bank. If it didn't reach the correct answer after three attempts, the item-scenario pair was discarded. Within each of these attempts, if an error was encountered (e.g., an exception was generated due to an improperly formatted function call), then the error message was added to the prompt and the LM was allowed to continue. If the number of errors exceeded 3 in an attempt, then that attempt was abandoned. This resulted in a shot bank size of 203 items.

For the test set, the study provided the full rule set and JSON of available functions. Multiple conditions were then compared:

Shot count: The number of shots included in the prompt varied from 0 to 10.

Shot selection: We either used SBERT [Reimers and Gurevych, 2019] to select similar shots (as described above), or selected them randomly.

Function call and rationale inclusion: When including shots, we experimented with including the list of function calls that were successful in answering each shot, and including the rationale provided by the LM.

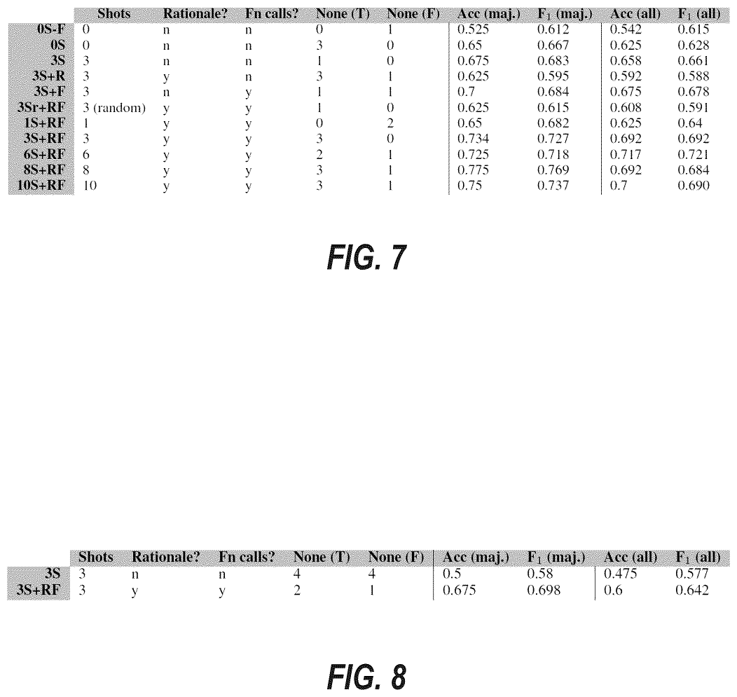

LM used: Unless otherwise stated, the study used OpenAI's gpt-4-606-preview model, as it is at present the only LLM that both has a context size large enough to fit the entire ruleset and shots in its prompt, and has an API that natively supports function calling. For a few cases, the study also used gpt-3.5-turbo-606. All results are listed in FIG. 7 (for GPT-4 results) and FIG. 8 (for GPT-3.5 results). For all of these conditions, the LM is given three attempts to solve the problem. The majority vote is considered its answer, but if there is no majority (due to errors or improperly formatted outputs, the number of which are in the “None” columns), then we consider the answer to be LEGAL.

Effects of shot sizes. Across all metrics, adding more shots seems to increase performance, until roughly 6 shots. After that, the benefits are no longer clear. Comparing 3Sr+RF (where shots are randomly chosen) and 3S+RF (where shots are chosen using SBERT), we see a substantial increase in performance, suggesting that the LM's improvement is not merely a matter of having more shots to provide examples of any BG-related reasoning-rather, having examples of how to perform reasoning that is similar to that likely to be used in the current problem is most helpful.

Effects of including function calls and rationales. There is a minimal positive increase in performance from 3S to 3S+F. However, the difference between 3S and 3S+R is actually negative, suggesting that the inclusion of rationales without examples of function calls actually harmed performance. However, 3S++RF again outperforms 3S+R and 3S+F.

Effects of LLM used. With GPT-3.5, 3S performed roughly at chance (FIG. 8), but was significantly improved with 3S+RF. Both conditions performed better with GPT-4, as expected.

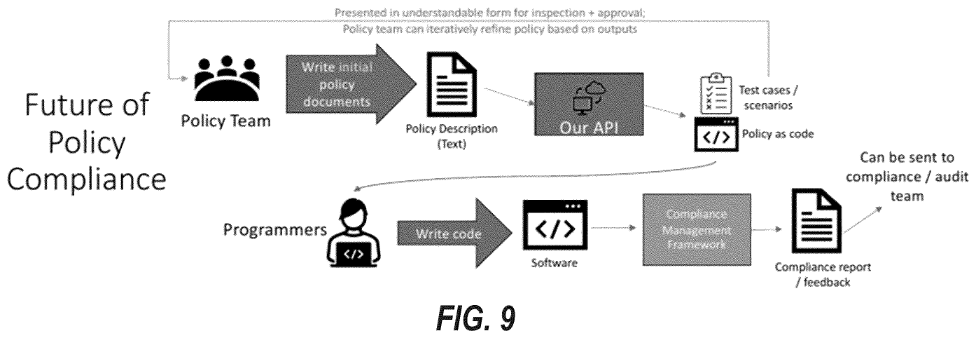

Implementations of the present disclosure can not only include frameworks so that LMs can reason about action permissibility according to open-textured rules, but also frameworks that allow the LMs to justify their conclusions. And those justifications, ideally, would be in a form that acknowledges potential controversy or sources of interpretive disagreement where it exists, rather than ignoring it. FIG. 9 illustrates an example method for generating formal representations of text, according to implementations of the present disclosure.

The study included a benchmark dataset for studying how well LMs can reason about action permissibility in realistic, complex, open-textured rule sets. The study introduced the methodology for creating this dataset, and showed that naïve querying of even state-of-the-art LMs like GPT-4 may result in no better than random behavior. More advanced prompting methods, such as those using 6 or more shots, along with example function calls and rationales as part of the shots, perform significantly better, but still do not surpass 80% accuracy.

Implementations of the present disclosure can further include providing different examples provided in the input shots, and generalizing the generalize the reasoning used by multiple shots to produce interpretable, repeatable procedures that can also be inspected by human experts.

It should be appreciated that the logical operations described herein with respect to the various figures may be implemented (1) as a sequence of computer implemented acts or program modules (i.e., software) running on a computing device (e.g., the computing device described in FIG. 10), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 10, an example computing device 1000 upon which the methods described herein may be implemented is illustrated. It should be understood that the example computing device 1000 is only one example of a suitable computing environment upon which the methods described herein may be implemented. Optionally, the computing device 1000 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 1000 typically includes at least one processing unit 1006 and system memory 1004. Depending on the exact configuration and type of computing device, system memory 1004 may be volatile (such as random access memory (RAM)), non-volatile (such as read-only memory (ROM), flash memory, etc.), or some combination of the two. This most basic configuration is illustrated in FIG. 10 by dashed line 1002. The processing unit 1006 may be a standard programmable processor that performs arithmetic and logic operations necessary for operation of the computing device 1000. The computing device 1000 may also include a bus or other communication mechanism for communicating information among various components of the computing device 1000.

Computing device 1000 may have additional features/functionality. For example, computing device 1000 may include additional storage such as removable storage 1008 and non-removable storage 1010 including, but not limited to, magnetic or optical disks or tapes. Computing device 1000 may also contain network connection(s) 1016 that allow the device to communicate with other devices. Computing device 1000 may also have input device(s) 1014 such as a keyboard, mouse, touch screen, etc. Output device(s) 1012 such as a display, speakers, printer, etc. may also be included. The additional devices may be connected to the bus in order to facilitate communication of data among the components of the computing device 1000. All these devices are well known in the art and need not be discussed at length here.

The processing unit 1006 may be configured to execute program code encoded in tangible, computer-readable media. Tangible, computer-readable media refers to any media that is capable of providing data that causes the computing device 1000 (i.e., a machine) to operate in a particular fashion. Various computer-readable media may be utilized to provide instructions to the processing unit 1006 for execution. Example tangible, computer-readable media may include, but is not limited to, volatile media, non-volatile media, removable media and non-removable media implemented in any method or technology for storage of information such as computer readable instructions, data structures, program modules or other data. System memory 1004, removable storage 1008, and non-removable storage 1010 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1006 may execute program code stored in the system memory 1004. For example, the bus may carry data to the system memory 1004, from which the processing unit 1006 receives and executes instructions. The data received by the system memory 1004 may optionally be stored on the removable storage 1008 or the non-removable storage 1010 before or after execution by the processing unit 1006.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### REFERENCES

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

[Bai et al., 2022] Yuntao Bai, Saurav Kadavath, Sandipan Kundu, Amanda Askell, Jackson Kernion, Andy Jones, Anna Chen, Anna Goldie, Azalia Mirhoseini, Cameron Mckinnon, Carol Chen, Catherine Olsson, Christopher Olah, Danny Hernandez, Dawn Drain, Deep Ganguli, Dustin Li, Eli Tran-Johnson, Ethan Perez, Jamie Kerr, Jared Mueller, Jeffrey Ladish, Joshua Landau, Kamal Ndousse, Kamile Lukosuite, Liane Lovitt, Michael Sellitto, Nelson Elhage, Nicholas Schiefer, Noemi Mercado, Nova DasSarma, Robert Lasenby, Robin Larson, Sam Ringer, Scott Johnston, Shauna Kravec, Sheer El Showk, Stanislav Fort, Tamera Lanham, Timothy Telleen-Lawton, Tom Conerly, Tom Henighan, Tristan Hume, Samuel R. Bowman, Zac Hatfield-Dodds, Ben Mann, Dario Amodei, Nicholas Joseph, Sam McCandlish, Tom Brown, and Jared

Kaplan. Constitutional ai: Harmlessness from ai feedback, 2022.

[bgg, 2023] Next war: Taiwan, November 2023.

[Franklin, 2012] James Franklin. Discussion paper: How Much of Commonsense and Legal Reasoning is Formalizable? A Review of Conceptual Obstacles. Law, Probability and Risk, 11(2-3):225-245, June-September 2012.

[gmt, 2023] Gmt games—next war: Taiwan 2nd edition, November 2023.

[Hart, 1961] H. L. A. Hart. The Concept of Law. Clarendon Press, 1961.

[Land, 2014] Mitchell Land. Next war: Taiwan, 2014.

[Land, 2017] Mitchell Land. Next war: Poland, 2017.

[Licato and Marji, 2018] John Licato and Zaid Marji. Probing formal/informal misalignment with the loophole task. In Proceedings of the 2018 International Conference on Robot Ethics and Standards (ICRES 2018), 2018.

[Licato et al., 2019] John Licato, Zaid Marji, and Sophia Abraham. Scenarios and recommendations for ethical interpretive ai. In Proceedings of the AAAI 2019 Fall Symposium on Human-Centered AI, Arlington, VA, 2019.

[Licato, 2021] John Licato. How Should AI Interpret Rules? A Defense of Minimally Defeasible Interpretive Argumentation. arXiv e-prints, 2021.

[Prakken, 2017] Henry Prakken. On the problem of making autonomous vehicles conform to traffic law. Artificial Intelligence and Law, 25(3):341-363, September 2017.

[Quandt and Licato, 2020] Ryan Quandt and John Licato. Problems of Autonomous Agents following Informal, Open-textured Rules. In William F. Lawless, Ranjeev Mittu, and Donald A. Sofge, editors, Human-Machine Shared Contexts. Academic Press, 2020.

[Rebedea et al., 2023] Traian Rebedea, Razvan Dinu, Makesh Sreedhar, Christopher Parisien, and Jonathan Cohen. Nemo guardrails: A toolkit for controllable and safe 1 lm applications with programmable rails, 2023.

[Reimers and Gurevych, 2019] Nils Reimers and Iryna Gurevych. Sentence-BERT: Sentence embeddings using Siamese BERT-networks. In Kentaro Inui, Jing Jiang, Vincent Ng, and Xiaojun Wan, editors, Proceedings of the 2019 Conference on Empirical Methods in Natural Language Processing and the 9th International Joint Conference on Natural Language Processing (EMNLP-IJCNLP), pages 3982-3992, Hong Kong, China, November 2019. Association for Computational Linguistics.

[Waismann, 1965] Friedrich Waismann. The Principles of Linguistic Philosophy. St. Martins Press, 1965.

What is claimed:

1. A system comprising:
a first large language model;
a memory storing instructions and
one or more processors operable to execute the instruction to:
receive a natural language text string from an input computing device, wherein the natural language text string comprises a formal rule expressed in natural language;
input the natural language text string and a control string into a large language model (LLM), wherein the control string is configured to cause the LLM to generate a formal expression representing the formal rule of the natural language text string;
output, by the large language model, the formal expression to an output device; and
evaluate a consistency of the formal expression using a test input.

2. The system of claim 1, wherein the formal expression comprises Boolean logic.

3. The system of claim 1, wherein the formal expression comprises programming language syntax.

4. The system of claim 1 wherein the memory comprises additional executable instructions that, when executed by the one or more processors cause the one or more processors to:
create a modified control string based on the consistency of the formal expression;
input the natural language text string and the modified control string into the large language model; and
output, by the large language model, a second formal expression.

5. The system of claim 4, wherein the modified control string is configured to configure the large language model to improve the consistency of the second formal expression.

6. The system of claim 1, wherein the test input comprises a plurality of inputs and a plurality of corresponding outputs for the formal expression.

7. The system of claim 6, further comprising a second large language model, and wherein the memory comprises additional executable instructions that, when executed by the one or more processors cause the one or more processors to: generate, by a second large language model, the plurality of inputs and the plurality of corresponding outputs for the formal expression.

8. A computer-implemented method of natural language processing comprising:
receiving a natural language text string, wherein the natural language text string comprises a formal rule expressed in natural language;
inputting the natural language text string and a control string into a large language model (LLM), wherein the control string is configured to cause the LLM to generate a formal expression representing the formal rule of the natural language text string;
outputting, by the large language model, the formal expression; and
evaluating a consistency of the formal expression using a test input.

9. The computer-implemented method of claim 8, wherein the formal expression comprises Boolean logic.

10. The computer-implemented method of claim 8, wherein the formal expression comprises programming language syntax.

11. The computer-implemented method of claim 8, further comprising:
creating a modified control string based on the consistency of the formal expression;
inputting the natural language text string and the modified control string into the large language model; and
outputting, by the large language model, a second formal expression.

12. The computer-implemented method of claim 11, wherein the modified control string is configured to configure the large language model to improve the consistency of the second formal expression.

13. The computer-implemented method of claim 8, wherein the test input comprises a plurality of inputs and a plurality of corresponding outputs for the formal expression.

14. The computer-implemented method of claim 13, wherein the method further comprises generating, by a second large language model, the plurality of inputs and the plurality of corresponding outputs for the formal expression.

15. A non-transitory computer-readable medium storing instructions thereon which, when executed by one or more processors, cause one or more computers to perform functions that include:
receiving a natural language text string, wherein the natural language text string comprises a formal rule expressed in natural language;
inputting the natural language text string and a control string into a large language model (LLM), wherein the control string is configured to cause the LLM to generate a formal expression representing the formal rule of the natural language text string;
outputting, by the large language model, the formal expression; and
evaluating a consistency of the formal expression using a test input.

16. The non-transitory computer-readable medium of claim 15, wherein the formal expression comprises programming language syntax or Boolean logic.

17. The non-transitory computer-readable medium of claim 15, further comprising additional executable instructions that, when executed by the one or more processors cause the one or more processors to:
create a modified control string based on the consistency of the formal expression;
input the natural language text string and the modified control string into the large language model; and
output, by the large language model, a second formal expression.

18. The non-transitory computer-readable medium of claim 17, wherein the modified control string is configured to configure the large language model to improve the consistency of the second formal expression.

19. The non-transitory computer-readable medium of claim 15, wherein the test input comprises a plurality of inputs and a plurality of corresponding outputs for the formal expression.

20. The non-transitory computer-readable medium of claim 19, further comprising additional executable instructions that, when executed by the one or more processors cause the one or more processors to: generate, by a second large language model, the plurality of inputs and the plurality of corresponding outputs for the formal expression.
